(19) United States
(12) Patent Application Publication
(10) Pub. No.: US 2018/0156921 A1
(43) Pub. Date: Jun. 7, 2018

(54) GNSS Visit Verification System

(71) Applicant: Thomas Eric Guttenberger, (US)

(72) Inventor: Thomas Eric Guttenberger, Dearborn, MI (US)

(21) Appl. No.: 15/831,398

(22) Filed: Dec. 5, 2017

Related U.S. Application Data
(60) Provisional application No. 62/430,799, filed on Dec. 6, 2016.

(51) Int. Cl. G01S 19/24; G01S 19/10; G06Q 20/32; G06Q 20/04; G06Q 20/40; G06F 17/30

(52) U.S. Cl. CPC G01S 19/24; G01S 19/10; G06F 17/30; G06Q 20/0453; G06Q 20/40; G06Q 20/3224

(57) ABSTRACT

A software system is provided for efficiently verifying mobile device user visits in response to a promotion by a business via a GNSS system. A GNSS coordinate check of the mobile device is initiated when a software object such as a digital receipt is opened or otherwise referenced. If the mobile device coordinates match the coordinates of the associated business at that time, the visit is verified. This process step allows the visit verification system to avoid the problems of continuously checking mobile device GNSS coordinates and comparing these coordinates against all possible promoting businesses. The result is a software system which verifies visits in response to a promotion while effectively minimizing the battery drain of the associated network of mobile devices, and host system computing operations.

### CROSS REFERENCE TO RELATED APPLICATIONS

Provisional application No. 62/430,799; filed on Dec. 6, 2016.

### BACKGROUND OF INVENTION

Businesses with store-front physical locations do not have knowledge of whether their promotions result in customer visits. Given the ability of a mobile device to check and record its coordinates via a GNSS system, it is possible to compare these coordinates to the coordinates of a business in order to verify a visit. Currently an obstacle to implementing a GNSS check method for this purpose is that the service which checks the coordinates of the mobile device would need to be constantly running on the phone, and the host computing system would need to compare the phone's GNSS coordinates against all possible businesses. Implementation without significantly reducing the required GNSS checks and comparisons is impractical because these operations drain the battery of the mobile device and increase the number of computing operations made by the host system.

By prompting a GNSS check of the mobile device based on specific events within a software application on the mobile device, a system here is developed to efficiently request GNSS coordinates from the mobile device and make comparisons between coordinates of the mobile device and business coordinates. Embodiments of the invention reduce GNSS coordinate checks and comparisons to times relating to user interactions, or automated events in the software. Comparisons of coordinates can be made against only the promoting business or against a reduced set of businesses from a database on the host computing system. The mobile device user is prompted through a software application to initiate events via elements such as the presentation of a promotion, or the generation of a digital coupon or receipt. These elements which prompt user interaction contribute to solve the problem of needing to check GNSS location continuously. The complete system enables practical implementation of verifying mobile device user visits of particular store-front business in response to a promotion. Verifying and recording mobile device user visits in response to a promotion is valuable information and can be used by a service provider to bill the promoting business in one possible application of the invention.

### FIELD OF INVENTION

This invention relates to an efficient system for verifying mobile device user visits related to a business promotion via a GNSS system.

### BRIEF SUMMARY OF THE INVENTION

A software system for efficiently verifying mobile device user visits associated with a promotion by a business via a GNSS system is disclosed. In an exemplary embodiment, mobile device user interactions with elements in the software application initiate GNSS coordinate checks and comparisons. These elements can include the presentation of a promotion, or the generation of a digital receipt or coupon. These elements used in combination with other process steps and logic allow the system to avoid the problems associated with continuously checking mobile device coordinates and comparing these coordinates against all possible promoting businesses. The result is a software system which significantly reduces the battery drain of mobile devices on its network, and host system computing operations. These improvements make the implementation of a system for verifying user visits in response to a promotion practical. Verification of customer visits in response to a specific promotion can enable resultant actions including billing of the promoting business by the service provider.

In one embodiment, the GNSS coordinate checks of the mobile device and comparison against coordinates of the business are limited to a particular time after that business promotion is sent to or opened from the software application. The comparisons during this time can be limited to the businesses associated with the sent or opened promotion. In this embodiment the GNSS checks are made at periodic intervals, and can be limited to a specific time window. The periodicity can be variable based on the distance of the mobile device to the promoting business, and can also be made variable with respect to the time elapsed after the promotion was sent or opened.

In another embodiment, the promotion acceptance software object, or digital coupon, is created automatically at the time of delivery of the promotion to the mobile device without any user interaction. In this embodiment the GNSS check initiator can be based on a user prompt as in the exemplary embodiment, or can be periodic in a defined time window after sending the promotion, as described in other embodiments.

In another embodiment the GNSS coordinate comparisons can be limited to those businesses whose promotions have at any time been sent to or viewed by the user. The list of businesses to make comparisons against can also be limited to those within a specific range of the GNSS coordinates at the time of the last GNSS coordinate check of the mobile device.

### BRIEF DESCRIPTION OF THE DRAWINGS

FIG. 1 is a flow chart illustrating the visit verification process.

### DETAILED DESCRIPTION OF THE INVENTION

The present disclosure relates to a system for verifying mobile device user visits of a business in response to a promotion in an efficient way. The present invention differs from what currently exists because a visit verification is confirmed via a GNSS service, and a method for reducing the number of GNSS coordinate checks and host system computing operations is described in detail. A GNSS service is understood to mean a Global Navigation Satellite System. Examples of GNSS services include GPS, GLONASS, or Galileo.

In contrast to other related work, there is no need for additional hardware at the location of the business to verify a visit, such as display items as described in U.S. Patent Publication number: U.S. 2014/0257957 A1. Also in contrast to U.S. Patent Publication number: 2010/0161507 A1, which describes a GPS Rating System, the invention herein gives a detailed specification for how to determine that the device has visited the business in an efficient manner.

Process steps and logical gates in the software application and host system are created which enable the efficient verification of a visit and are critical to the uniqueness of the disclosure herein. The software system described uses much less mobile device battery and requires less host system computing operations than any other GNSS method existing for verifying visits in response to a promotion.

By prompting a GNSS check based on specific user interactions within the mobile device software application, the invention reduces the GNSS coordinate checks to only specific events in the software. Process steps encourage user interactions at logical times in order to check and compare the GNSS coordinates of the mobile device to those of the promoting business. These process steps allow the system to avoid the problems of needing to check location continuously and against all possible businesses. The business coordinate comparisons can be limited to only those associated with the promotion(s) sent to the mobile device or those related to other user interactions.

The desired function of the invention is to determine whether a customer has visited a store-front business location after they have been sent or have opened a promotion from that business. The invention also describes how to do this efficiently with respect to battery usage of the phone and host system computing operations. Systems that do not reduce the number of checks to the mobile devices' GNSS coordinates, and the number of comparisons of these coordinates against businesses in the host system database are inefficient and impractical to implement. These frequent and required operations multiply together for each mobile device on the network and inefficiencies greatly increase the computing operations required by the host system. In an exemplary embodiment of the invention described herein the required GNSS checks and comparisons are each reduced to one.

Businesses register onto the system. In general, the registration can be comprised of user populated inputs or inputs which are automatically obtained. Users can register their own information through a digital form. Alternatively information such as business name, address, coordinates, and other pertinent details about the business can all be found by an automated search of the internet and input into the business database. This registration includes assignment of latitude and longitude coordinates. These coordinates can be input directly by the business or can be set via a drop pin map, address look up, or other similar service.

The business database(s) includes all unique locations of businesses for which promotions can be initiated through the system. These databases include the GNSS coordinates for each of these businesses. The records in these business databases can be populated based on a business registration onto the system or can be automatically obtained from other sources. Whether a business was registered with user inputs automatically can be an identifying field in these databases to determine characteristics for future process steps including promotion seeding, promotion delivery, promotion acceptance, resultant actions, and others.

Promotions are seeded by the business or automatically and these promotions are associated with the corresponding business in the business database(s). Promoting businesses input information which can include price, item description, valid date or times, tags, and other information. Alternatively a similar set of information can be populated through a service such as an automated web search. This information input by the business or automatically populated is then associated with the promotion and the business.

At some time after seeding, promotions are distributed to the network of associated mobile devices. The distribution of promotions via the software application can be displayed on the software application interface in a variety of ways including an automatic broadcasting service, a list, an image card interface, or others. Promotions can be distributed to these mobile devices based on the device GNSS coordinates, user set preferences, prior actions, or others. Any combination of these user characteristics can comprise the algorithm for priority of distributing these promotions. For example, the promotion with the nearest associated location can be sent with priority to particular mobile device on the network; or a promotion with the highest score on an aggregate algorithm can be sent to the device. The mobile devices on the network can be those which have installed the software application associated with the system.

In an exemplary embodiment, once the promotion has been delivered to the mobile device, a user click of the promotion acts as the event to create a promotion acceptance object, or digital receipt. This promotion acceptance object represents that the promotion was opened by the mobile device user. This promotion acceptance object can take the appearance of a digital receipt or coupon. With the appearance as a receipt or coupon associated with the promotion, there is incentive for the mobile device user to open this object at the location of the business. This promotion acceptance object can be saved locally on the phone, or it can be saved in a database on the host system.

In another embodiment, any promotion that is sent to the mobile device can automatically generate a promotion acceptance object. In this embodiment the mobile device application optionally can automatically notify the user of a receipt or coupon which has been sent to and generated to their mobile device. In this embodiment, the promotion acceptance object represents that the promotion was sent to the user.

When the promotion acceptance object, or digital receipt, is clicked, opened, or otherwise referenced by the mobile device user, the GNSS coordinates of the mobile device are checked and compared to that of the promoting business. In this exemplary embodiment it is apparent that the only instances of GNSS coordinate checks will be at the times these post acceptance objects are opened, clicked, or otherwise referenced by the mobile device user. It is also apparent that only a single GNSS coordinate comparison is needed between the mobile device and the promoting business. Therefore in execution of this step, the required number of GNSS checks and host system computing operations are each reduced to one.

In one embodiment the post acceptance object does not need to be clicked or otherwise referenced by the user. The GNSS checks will occur periodically after the post acceptance object was created. In this embodiment the periodic GNSS coordinate checks can be used to change the interval of how often remaining GNSS checks are made in the time window. For example, if the mobile device coordinates are estimated to be at least one hour travel time from the coordinates of the business, the GNSS checks can be made at this frequency. In this embodiment, the number of GNSS checks is reduced but not to the extent of the exemplary embodiment as described in the above paragraph.

At the time the post acceptance object is opened, clicked, or otherwise referenced a GNSS coordinate comparison will be made between the mobile device and the promoting business. GNSS coordinates of the mobile device at the time of the comparison need to be within a specified threshold of the coordinates of the particular business as recorded in the host system database to initiate the resultant actions. The coordinate comparisons can carried out by establishing an acceptance range for both longitude and latitude, or with an acceptance range based on calculated radial distance. For example, if the digital receipt is opened on the mobile device at a location of the business within a specified margin for error, the system will record the visit, and resultant actions will ensue. But if the longitude and latitude combination is outside the acceptance range of the business, there will be no resultant actions.

These resultant actions can include notifying the business of a customer visit, recording the visit in the business database, billing the business for the verified visit, or various others. Billing the business for the verified visit can be done in proportion to the value of the promotion. For example, the business can create a promotion with an associated value of $100, and a service provider can bill the business as a percentage of that value. Here a service provider is understood to be the entity distributing the promotions or managing services related to those promotions. These services can include maintaining records of the business promotions, maintaining promotion or business databases, distributing the mobile device software application, or others.

Knowledge of customer visits help businesses gain visibility about their promotions, and in one application of this technology, can be used as the basis for billing by a service provider. For example, the business could pay the service provider a percentage value of a particular promotion once it is established through this method that a mobile device user has visited the business in response to the promotion. Here the service provider can also have an established system for recording all relevant data associated with the promotions. This can include the number of times the promotions have been viewed, the number of times these promotions have been visited, the value of each promotion, and others. These are just some possible applications of this method for verifying customer visits.

By establishing the business GNSS coordinates, and introducing process steps in a mobile software application, the system as described effectively limits GNSS coordinate checks and comparisons. The invention can efficiently determine whether the user of a mobile device has visited a business in response to a promotion without needing to constantly check the GNSS coordinates of the mobile device. Using a digital receipt or coupon is effective as a user prompt, and this software event can initiate the GNSS coordinate check and comparison. This embodiment reduces the number of GNSS coordinate checks to a single event, as opposed to needing to check these coordinates constantly. Also only a single business coordinate comparison is needed, as opposed to potentially millions. The system described allows mobile devices on this network perform this function with minimal battery drain and allow a reduction in computing operations made by the host system.

Alternative processes are discussed for each of the process steps of the invention. In the description provided above, the exemplary embodiment for each process step is described, then alternatives for these steps are also described. Any combination of these alternative processes is possible and should be considered within the scope of the invention. Different combinations of embodiments can be considered most useful for implementation depending on the desired system objective.

The invention is made with computer code which is executed on mobile devices or a host computing system. This computer code can be written in Java, C++, Objective-C, PHP, Javascript, HTML, SQL, Python, or any combination of these or similar languages. Components of this code can be distributed between the mobile software application or the host computing system.

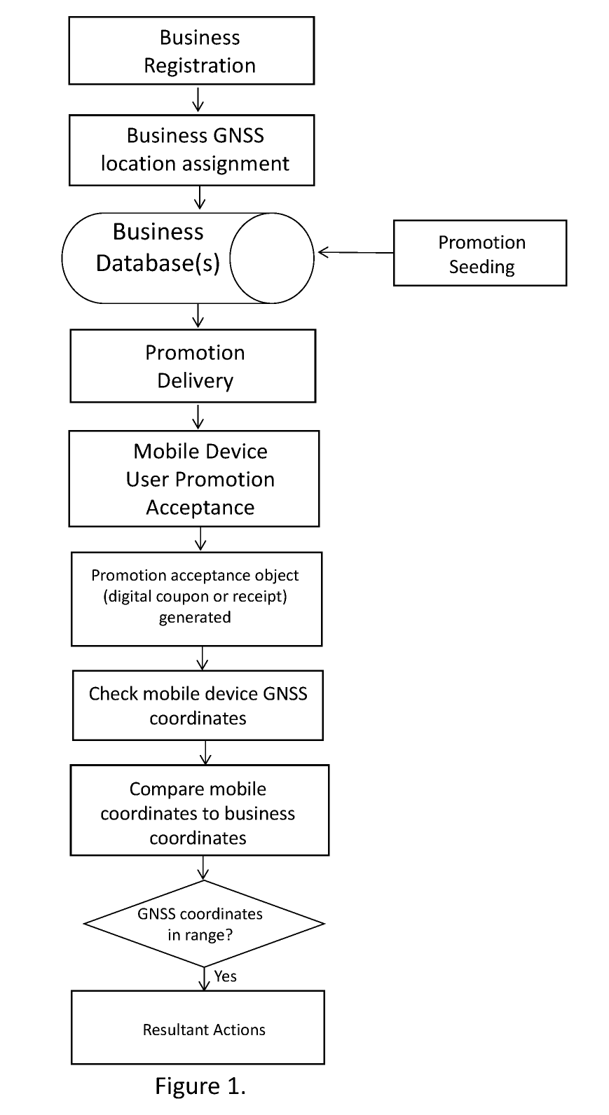

Some alternatives to each component or process step as shown in FIG. 1 are described and these alternatives can be implemented in any combination when making the invention. For example, including an automated process for adding businesses to the database whose promotions are distributed via a list view of these records, with a periodic GNSS coordinate check after the digital receipt has been generated is one possible embodiment. Any combination of the alternatives for each step described throughout this disclosure is possible and should be considered within the scope of this invention.

People can easily use the invention by interacting with the mobile device software application interface. This mobile software application uses significantly less battery than any similar software application achieving the purpose of verifying a customer visit in response to a business promotion via GNSS. Businesses can use the invention by creating promotions on a web or mobile interface. In an application of the invention, businesses can view the results of these promotions including number of customer visits, number of times the promotions were delivered, billing totals, and other relevant information. Any application needing to verify whether the user of a mobile device has visited a particular location would have a use for this method.

In the preceding detailed description, various embodiments are described. These embodiments should be taken as illustrative and not restrictive. With this disclosue, several variations should be apparent to those skilled in the art. These variations can be made without a departure from the scope of the disclosure as set forth in the claims.

What is claimed is:

1. A system for verifying visits in response to a promotion, comprising: a mobile device with GNSS capability, wherein a software application checks the mobile device GNSS coordinates and makes a comparison of these coordinates against coordinates of the promoting business in an efficient way.

2. The visit verification method of claim 1, wherein the software application accepts a user interaction with the promotion to generate a digital receipt.

3. The visit verification method of claim 1, wherein the software application automatically generates a digital receipt for any sent promotion.

4. The visit verification method of claim 1, wherein the software application initiates a GNSS coordinate check of the mobile device only at the time of a user interaction with a digital receipt associated with the promotion.

5. The visited verification method of claim 1, wherein the GNSS coordinate comparison is limited to that between the mobile device and the business associated with the digital receipt or promotion.

6. The visit verification method of claim 1, wherein the software application checks GNSS coordinates of the mobile device and makes comparisons against businesses automatically and periodically at a fixed time interval after the promotion has been sent to the mobile device.

7. The visit verification method of claim 1, wherein the software application makes GNSS coordinate comparisons automatically and periodically at a variable time interval with respect to the distance of the mobile device to the promoting business.

8. The visit verification method of claim 1, wherein the GNSS coordinate comparisons are made only against businesses associated with promotions which have ever been sent to the mobile device.

9. The visit verification method of claim 1, wherein the GNSS coordinate comparisons are made only against those business which are in a specified range of the mobile device at the time of its last coordinate check.

10. The visit verification method of claim 1, wherein the mobile device is a cell phone with GNSS capability.

11. The visit verification method of claim 1, wherein the mobile device is a handheld with GNSS capability.

12. The visit verification method of claim 1, wherein the mobile device is in a motor vehicle with GNSS capability.

13. A system for recording the verified visits, wherein information associated with each promotion is stored in a database.

14. The system for recording the verified visits of claim 13, wherein a resultant action is a fee charged to the promoting business by the promotion service provider.

15. The system for recording the verified visits of claim 13, wherein the fee charged to the promoting business by the promotion service provider is in proportion to the value of the promotion.

16. The system for recording the verified visits of claim 13, wherein the promoting business is notified of visits.

17. The system for recording the verified visits of claim 13, wherein the promoting business is displayed all recorded information relating to their promotions.
